(19) United States
(12) Patent Application Publication
(10) Pub. No.: US 2010/0005410 A1
(43) Pub. Date: Jan. 7, 2010

(54) MOBILE DEVICE APPLICATION FRAMEWORK

(76) Inventor: Xin PANG, Beijing (CN)

Correspondence Address: ARENT FOX LLP, 1050 CONNECTICUT AVENUE, N.W., SUITE 400, WASHINGTON, DC, 20036, US

(21) Appl. No.: 12/496,231

(22) Filed: Jul. 1, 2009

Related U.S. Application Data
(60) Provisional application No. 61/078,041, filed on Jul. 3, 2008.

(51) Int. Cl. G06F 3/048

(52) U.S. Cl. 715/765

(57) ABSTRACT

Methods and systems for enabling mobile devices to run a variety of content-carrying script programs using a standard script language, without the confines of operating within a network browser. A client layer has a Script-to-Document Object Model (DOM) engine that executes a content-carrying-script file, efficiently interprets the script and delivers interactive objects to a dynamic environment to provide end user services. The script-to-DOM engine can construct the DOM object on any device in a computationally efficient manner, while also updating objects on a dynamic basis. The constructed DOM object suitably matches the client device environment requirements and interacts with users without the need of complete refresh of the client layer, and generation/modification of the content structure becomes possible during buildup.

### RELATED APPLICATIONS

This application claims the benefit of U.S. Provisional Application No. 61/078,041 titled “Mobile Device Application Framework” filed Jul. 3, 2008, the entire contents of which are incorporated by reference herein.

### BACKGROUND OF THE INVENTION

1. Field of the Invention

Aspects of the present invention relate to an innovative mobile device application framework, and specifically to methods and systems that enable mobile devices to run a variety of content-carrying script programs at runtime. In particular, aspects of the present invention relate to methods and systems that allow the access, execution and distribution of network (e.g., World Wide Web (WWW)) and other content, via a downloadable or otherwise accessible client application, directly from a mobile device, such as a mobile telephone, Personal Digital Assistant (PDA), BlackBerry®, or the like. Aspects of the present invention relate to execution of content-carrying script programs on a mobile device without the confines of operating within a network browser.

2. Background of the Related Art

There are known in the art systems and methods for accessing content and allowing application execution using mobile devices. Some existing approaches that use an eXtensible Markup Language (XML) and Hypertext Markup Language (HTML) browser, however, typically have many problems, including those relating to deficiencies in mobile device browsers, lack of mobile device standardization, cumbersomeness of application development, and lack of standards (or failure to observe standards on the part of developers), among other problems. In addition, conventional mobile telephones are generally not equipped with the computing power or storage memory (also interchangeably referred to herein as a footprint or a storage footprint) to execute complex applications, such as full-featured browsers, including XML and HTML parsers.

Traditional content clients (e.g., WWW browsers) use XML/HTML files as the format for carrying and transmitting contents to clients. The XML/HTML file structure, which is generally static, defines the layout of the contents structure and the user interface (UI) elements, As the XML/HTML format is non-flexible and/or fixed, once the layout of the website is determined by the XML/HTML files, enabling interactivity may require additional network resources and Computer Processing Unit (CPU) cycles, among other resources, Traditional clients may combine scripts, such as Javascript, into the XML/HTML files to add dynamic features to the static contents or to include interactive features with the contents. However, such scripts, even when embedded within XML/HTML files, can only be executed after the XML/HTML file has been parsed and interpreted, which consumes valuable network and memory resources, as well as additional computational resources. When XML/HTML is compared with scripts, such as Javascript, such XML/HTML structures are still mostly non-flexible. For example, the XML/HTML defined contents have little or no capability for dynamic change/modification based on external inputs or client environment factors, such as screen size, for example. Current WWW application servers, such as the Hypertext Preprocessor (PHP) and the Java-HTTP-Server use server side servlet/servlet pages to add limited dynamic features to the XML/HTML, including modifying content based on user client browser type and user session, among other features. However, such servers lack the capability to retrieve users' client environment factors such as screen size, input methods, and browsing history, among other factors. Some client-side scripts may be applied for retrieving client environment factors; however, because the content structure/UI elements layout are defined by XML/HTML, client scripts are limited to utilizing indirect ways to apply dynamic features to the contents. For devices such as mobile phones, such indirect ways are inefficient for their low computing power.

Furthermore, the non-flexibility of the XML/HTML format requires considerable amount of testing prior to its commercial release. XML/HTML requires that specific Data Type Definitions be written and tested for each mobile telephone handset model. As there are several hundred handsets commercially available in any given market, considerable expense with respect to time, financial and human resources may be expended to test and modify content/services to ensure correct operation. This feature of the prior art systems is expensive and time-consuming to mobile operators, content providers and ultimately consumers.

More recently, frameworks that allow application and web content access and delivery via mobile devices have begun to emerge. Examples of these frameworks include Yahoo! Go, Mojax and Widsets. These frameworks, however, also generally suffer from a variety of deficiencies, including the following: the use of XML/HTML files for content definition, which leads to lack of flexibility when the contents are run on different devices; the use of non-standardized script languages, such as Blueprint and Java-like languages; use of large footprints on the mobile device; slow script execution speeds; weak, single-level cross-site scripting, without ability of changing on the fly; the inability to allow multiple applications/content services running in parallel fashion or interlinked to enable complex features; low capabilities, if any, for communication with other networks; little or no possibility for users to compile and execute scripts; inability to work with desktop browsers, such as Internet Explorer (IE), Firefox® and Safari; and lack of capability for customizing to operator portals; among other deficiencies.

U.S. Pat. No. 7,398,055 discloses multiple scripts, each of which is associated with an identifier of an electronic or mobile device, in which the script is executed. Such concept requires defining respective scripts for different client terminals, i.e., mobile devices, such as cellular telephones. All scripts are stored in the client terminals. Besides, this prior art uses XML/HTML files for content definition. As described above, the XML/HTML files lack of flexibility and cannot be changed dynamically.

U.S. Patent Publication No. 2005/0197157 discloses a system operable on a small mobile device, such as a smart phone, which uses descriptive languages with a similar style to markup languages that are used in a thin client but having features characteristic of a fat client. Such a system is able to handle more complicated content, but also suffers from the drawbacks associated with using XML/HTML files for content definition.

There is a need in the art, therefore, for methods and systems that provide a framework for running content-rich files on mobile devices without the confines of operating within a web browser; that use standardized script languages; that provide ease, flexibility and efficiency in modifying content based on the client environment and/or application dynamic features; have small storage footprints; have fast script execution speeds with minimal CPU requirements and strong multi-level cross-site scripting, including the ability of changing on the fly; strong levels of communication with other networks and/or direct web browsing; that provide users with the ability to compile and execute media-rich scripts; that have the capability to work with desktop browsers, such as IE, Firefox® and Safari on both traditional and mobile devices; and that are capable of customization to operator portals; that minimizes the coding and testing effort to provide content for a wide range of mobile devices.

### SUMMARY OF THE INVENTION

Aspects of the present invention address the above identified needs, as well as others, by providing a client layer, developed in C++, JavaScript or other client-native programming language, which, when executed at the client, provides a standardized framework that simulates a network browser environment for running network-based and other content on mobile devices without the constraints of operating within a network browser, and that provides ease and flexibility in modifying content based on the client environment or dynamic features.

Specifically, aspects of the invention solve the above needs, and others, by completely using a standard script language, such as JavaScript, and by occupying a small storage footprint. Unlike other frameworks, the contents, in accordance with aspects of the invention, may be carried by a client script source program, not XML/HTML files or other non-client script programs. The client layer has a Script-to-Document Object Model (DOM) engine that can execute a content-carrying-script file, which efficiently interprets the script and delivers interactive objects to a dynamic environment to deliver end user services.

Aspects of the present invention provide a method for interpreting and conveying environment description information, such as, but not limited to, device screen size and font size. The Script-to-DOM engine can construct the DOM object on any device in a computationally efficient manner, while also updating objects on a dynamic basis. In this manner, the constructed DOM object can suitably match the client device environment requirements and interact with users more efficiently without the need of a wholesale refresh of the client layer, in accordance with aspects of the present invention. Because the content structure is provided in the form of execution of scripts, with the client environment information provided in the Script-to-DOM engine, generation/modification of the content structure becomes possible during buildup. Conversely, most conventional frameworks' content structure is defined and parsed via XML/HTML files, and scripts may be executed to modify content structure only after it is built up by the XML/HTML parser. Unlike the conventional frameworks, in accordance with aspects of the present invention, the end-users may dynamically change the content structure and execute interactive features directly on a mobile device without going through a server or downloading special software.

Aspects of the present invention also provide fast script execution speeds and strong multi-level cross-site scripting, including the ability of changing on the fly, as well as strong levels of communication with other networks and/or direct web browsing. Further, aspects of the present invention provide users with the ability to compile and execute scripts, to work with desktop browsers, such as IE, Firefox® and Safari, and to customize to operator portals. Aspects of the present invention allow different applications/contents to run in parallel or embedded in each other to implement complex features.

Variations of the present invention provide the above features, and others, without losing the full layout of a web page, for example, while delivering an experience that is similar to a desktop and/or laptop environment.

Additional advantages and novel features of various aspects of the present invention will be set forth in part in the description that follows, and in part will become more apparent to those skilled in the art upon examination of the following or upon learning by practice thereof.

### BRIEF DESCRIPTION OF THE DRAWINGS

FIG. 1 illustrates an exemplary Java content-distribution framework (JCF) system architecture, in accordance with aspects of the present invention;

FIG. 2 presents a flowchart showing an exemplary operation of a client browser, in accordance with aspects of the present invention;

FIG. 3 presents an example of an open system framework for running web-based applications on a mobile device without using an XML or HTML parser, in accordance with aspects of the present invention;

FIG. 4 shows an exemplary method for running web-based applications on a mobile device in accordance with aspects of the present invention;

FIG. 5 presents an exemplary system diagram of various hardware components and other features, for use in accordance with aspects of the present invention; and

FIG. 6 is a block diagram of various exemplary system components, in accordance with aspects of the present invention.

### DETAILED DESCRIPTION OF THE INVENTION

According to aspects of the present invention, the open system may be carried out under a Javascript content-distribution framework (JCF). JCF is a cross-platform rich web/multimedia content distribution system and the core of the JCF is a content carrying file, interchangeably referred to herein as a JCF file or a Javascript program. The result of execution of the JCF file on a client device, such as a mobile device, is a DOM standard based content-defined object (CDO), which describes a logic structure of a dynamic content (e.g., a web-page), a user interface graphical layout, and user interactive scripts. A JCF client may render the content (e.g., a web-page) on a client device and interact with user inputs. In accordance with aspects of the present invention, the JCF client may be any Java Two Micro Edition (J2ME) enabled mobile device, any Open OS enabled smart device, such as a Symbian OS phone or a Windows Mobile phone, or any other device having similar features. The JCF client may also be implemented in, e.g., desktop browsers, such as Internet Explorer, Firefox or Safari, among others.

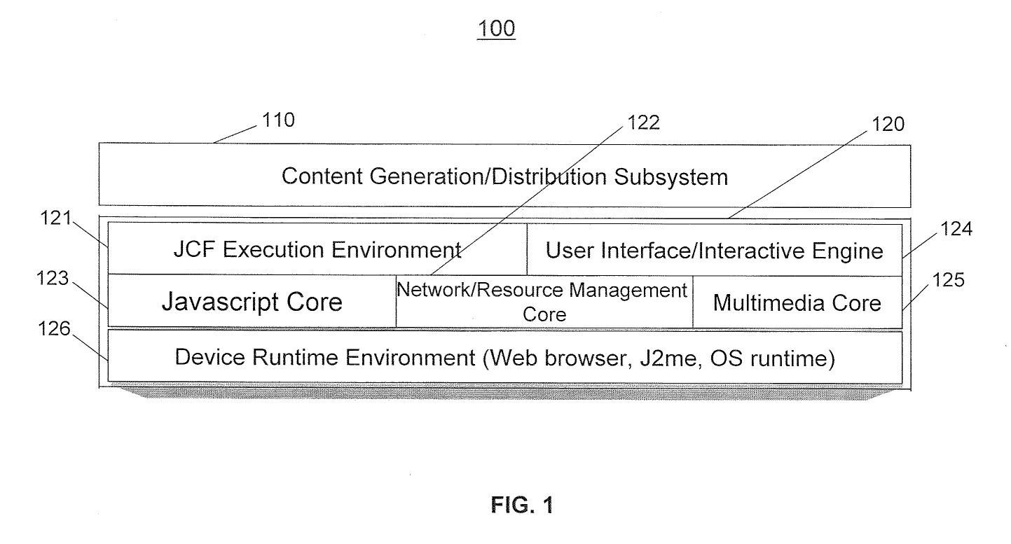

Referring now to FIG. 1, therein illustrated, in accordance with aspects of the present invention, is an exemplary Java content-distribution framework (JCF) client system architecture 100, which comprises at least two subsystems, including a content generation/distribution subsystem (server) 110 and a client browser subsystem (client) 120. The content generation/distribution subsystem 110 is based on common web-application servers that can comprise any dynamic page enabled web server, such as Apache/Tomcat, Weblogic, Sun one, and PHP, among others. A HTML-JCF translating component may enable the JCF server to translate most HTML based contents into JCF format.

The client browser subsystem 120 may include a JCF execution environment 121, a user interface engine 124, a Javascript engine including a Javascript core 123, a network/resource management core 122, and a multimedia core 125. Further, the client browser subsystem 120 may include a device runtime environment (i.e., a core-function enabler), such as Javascript runtime/network engine 126.

In operation, in accordance with aspects of the present invention, the JCF client browser subsystem 120 may be built-in on a client device, or may be downloaded to the client device from a web server upon subscription.

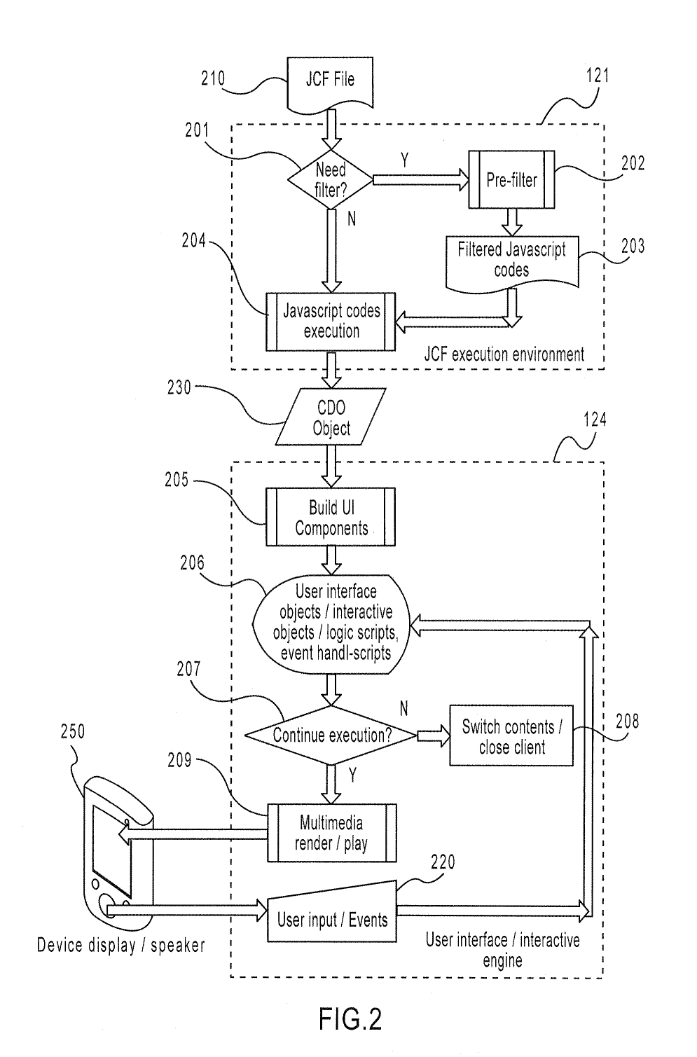

Referring now to FIG. 2, therein shown is a flowchart of an exemplary operation of client browser subsystem 120, in accordance with aspects of the present invention. Client browser subsystem 120 receives JCF files 210 via network or file system from the server subsystem 110 or a local file system. If the JCF file needs to be filtered 201, the JCF execution environment 121 pre-filters 202 the JCF file. The JCF execution environment 121 executes 204 the filtered Javascript program (input from step 203) or the unfiltered Javascript program (input from step 201) to construct the CDO object. The CDO object is then executed at the user interface interactive engine 124.

Based on the CDO object, the user interface/interactive engine 124 builds a user interface (UI) component 205, and composes one or more user interface objects, interactive objects, logic scripts, and event handling-scripts, among others, 206. If no further execution is required 207, the user interface/interactive engine 124 closes the client and switches contents 208. If further execution is required, the user interface/interactive engine 124 plays the contents 209 via a client device, such as a display/speaker 250 via the multimedia core 122. According to aspects of the present invention, a user of the device display/speaker 250 may input events for executions.

Another exemplary variation of the present invention may operate as a client layer that can be downloaded and executed at a user's mobile device.

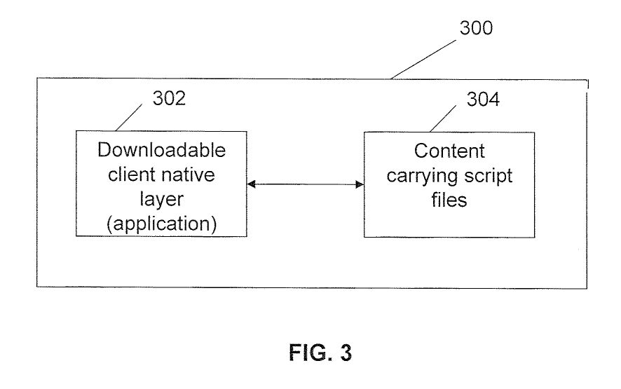

FIG. 3 shows an exemplary open system mobile framework 300 for running web-based content-carrying JavaScript files 304 (e.g., the JCF file), on a mobile device without using an XML or HTML parser, in accordance with aspects of the present invention. In accordance with one aspect, the web-based content-carrying JavaScript files 304 may be completely carried out in a JavaScript framework, or any other program with comparable features. Upon downloading to a user's mobile device, a client layer 302 is executed and becomes resident on the open system mobile framework 300. In accordance with aspects of the present invention, suitable content-carrying JavaScript files 304 may be executed within the framework 300, via the downloadable client layer 302, resulting in the content structure and interactive features being capable of being dynamically run/modified on the mobile device.

Once the content-carrying JavaScript files 304 are downloaded in the user's mobile device, it will be executed within a Script-to-DOM engine. The engine allows the objects within the client layer 302 to be updated by document object models according to the device information provided by the client layer 302 without a complete refresh of the client layer. For example, a text label can select suitable font size based on the client screen size. Furthermore, in accordance with one aspect, the JavaScript files 304 may have the capability to translate HTML based content to JavaScript format.

It will be appreciated that running a content-carrying JavaScript program on a mobile device may include executing a program, such as a video game, on the mobile device. However, it will also be recognized that running the content-carrying JavaScript program on a mobile device may also include, for example, displaying the content of a web page, or providing audio and/or visual content.

It should be noted that the downloadable client layer 302 may be provided as a Java Two Micro Edition (J2ME) program, or other program that has comparable features. Among the advantages of the open system mobile framework 300, in a JavaScript implementation, are that JavaScript is a powerful, object-oriented language, that many web pages and applications on the WWW, for example, are using JavaScript, and that JavaScript is a standard programming language, which would therefore not provide an incentive for software developers to deviate and/or customize individual programs/applications, thus increasing the likelihood of uniformity and standardization occurring in mobile device applications.

Moreover, in accordance with one aspect, by using the content-carrying JavaScript files 304, the coding of executing content for display may be reduced, thereby reducing the time of processing and displaying data, and data interaction on the user's mobile device.

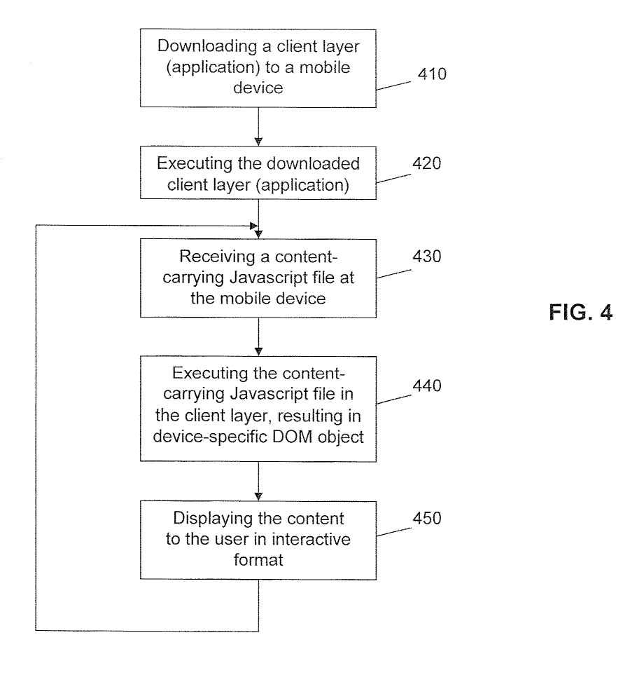

Referring now to FIG. 4, therein shown is an exemplary method for running web-based content applications on a mobile device without using an XML or HTML parser, in accordance with aspects of the present invention. A client layer is downloaded 410 to a mobile device. The client layer is executed 420. A content-carrying JavaScript file is received 430 at the mobile device, and executed via the client layer 440, without the use of an XML or HTML parser, resulting in a DOM object that adapts the client environment. The client layer provides the client environment information in the Script-to-DOM engine that executes the content-carrying Javascript file. Therefore, when executing the content-carrying file, the client layer can dynamically build up the DOM object that is suitable with respect to the client environment, such as the size of the display screen, the software used in the client device, or interactive features.

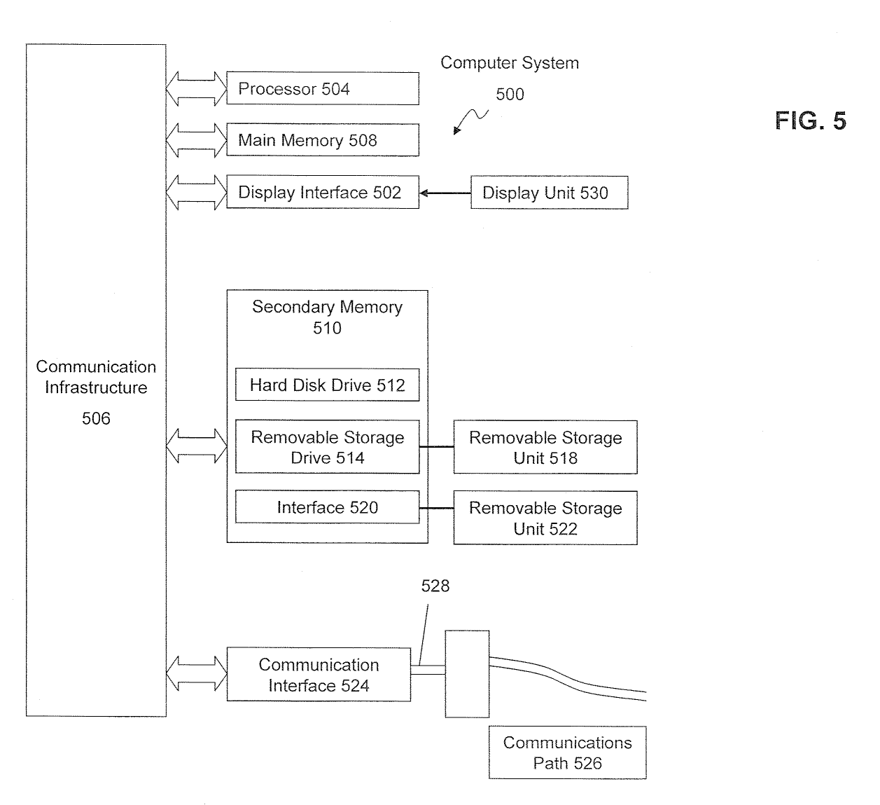

Variations of the present invention may be implemented using hardware, software, or a combination thereof and may be implemented in one or more computer systems or other processing systems. In one variation, aspects of the present invention are directed toward one or more computer systems capable of carrying out the functionality described herein. An example of such a computer system 500 is shown in FIG. 5.

Computer system 500 includes one or more processors, such as processor 504. The processor 504 is connected to a communication infrastructure 506 (e.g., a communications bus, cross-over bar, or network). Various software variations are described in terms of this exemplary computer system. After reading this description, it will become apparent to a person skilled in the relevant art(s) how to implement aspects of the present invention using other computer systems and/or architectures.

Computer system 500 can include a display interface 502 that forwards graphics, text, and other data from the communication infrastructure 506 (or from a frame buffer not shown) for display on a display unit 530. Computer system 500 also includes a main memory 508, preferably random access memory (RAM), and may also include a secondary memory 510. The secondary memory 510 may include, for example, a hard disk drive 512 and/or a removable storage drive 514, representing a floppy disk drive, a magnetic tape drive, an optical disk drive, etc. The removable storage drive 514 reads from and/or writes to a removable storage unit 518 in a well-known manner. Removable storage unit 518, represents a floppy disk, magnetic tape, optical disk, etc., which is read by and written to removable storage drive 514. As will be appreciated, the removable storage unit 518 includes a computer usable storage medium having stored therein computer software and/or data.

In alternative variations, secondary memory 510 may include other similar devices for allowing computer programs or other instructions to be loaded into computer system 500. Such devices may include, for example, a removable storage unit 522 and an interface 520. Examples of such may include a program cartridge and cartridge interface (such as that found in video game devices), a removable memory chip (such as an erasable programmable read only memory (EPROM), or programmable read only memory (PROM)) and associated socket, and other removable storage units 522 and interfaces 520, which allow software and data to be transferred from the removable storage unit 522 to computer system 500.

Computer system 500 may also include a communications interface 524. Communications interface 524 allows software and data to be transferred between computer system 500 and external devices. Examples of communications interface 524 may include a modem, a network interface (such as an Ethernet card), a communications port, a Personal Computer Memory Card International Association (PCMCIA) slot and card, etc. Software and data transferred via communications interface 524 are in the form of signals 528, which may be electronic, electromagnetic, optical or other signals capable of being received by communications interface 524. These signals 528 are provided to communications interface 524 via a communications path (e.g., channel) 526. This path 526 carries signals 528 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 580, a hard disk installed in hard disk drive 570, and signals 528. These computer program products provide software to the computer system 500. Aspects of the present invention are directed to such computer program products.

Computer programs (also referred to as computer control logic) are stored in main memory 508 and/or secondary memory 510. Computer programs may also be received via communications interface 524. Such computer programs, when executed, enable the computer system 500 to perform the features of various aspects of the present invention, as discussed herein. In particular, the computer programs, when executed, enable the processor 510 to perform such features. Accordingly, such computer programs represent controllers of the computer system 500.

In one variation of the present invention, which is implemented using software, the software may be stored in a computer program product and loaded into computer system 500 using removable storage drive 514, hard drive 512, or communications interface 520. The control logic (software), when executed by the processor 504, causes the processor 504 to perform the functions of the invention as described herein. Another variation is implemented primarily in hardware using, for example, hardware components, such as application specific integrated circuits (ASICs). Implementation of the hardware state machine so as to perform the functions described herein will be apparent to persons skilled in the relevant art(s).

In yet another variation, aspects of the present invention are implemented using a combination of both hardware and software.

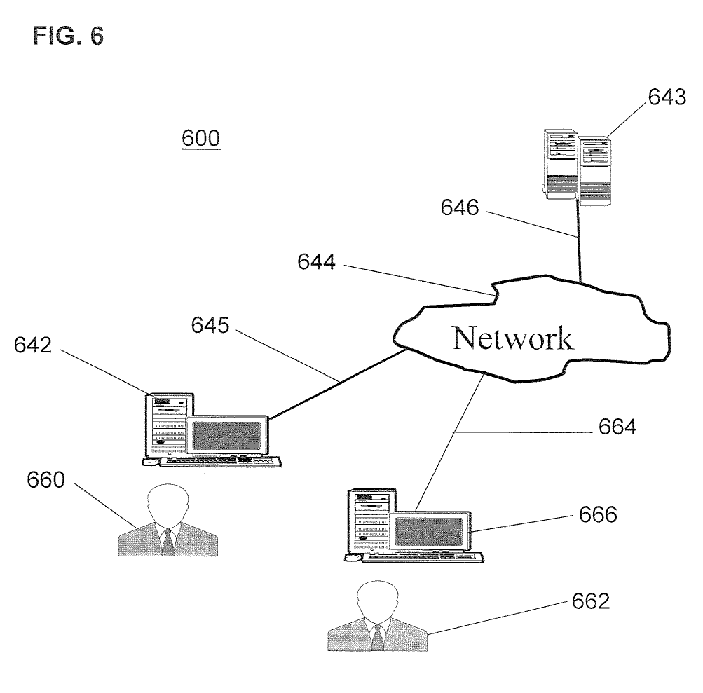

FIG. 6 shows a communication system 600 usable in accordance with aspects of the present invention. The communication system 600 includes one or more users 660, 662 (also referred to interchangeably herein as one or more “accessors”) and one or more mobile devices 642, 666. In one variation, data for use in accordance with aspects of the present invention is, for example, downloaded and/or accessed by users 660, 664 via terminals 642, 666, such as laptop computers or wireless devices, including PDAs or other hand-held wireless devices, coupled to a server 643, such as a laptop computer, mobile telephone or other device having a processor and a repository for data and/or connection to a repository for data, via, for example, a network 644, such as the Internet or an intranet, and couplings 645, 646, 664. The couplings 645, 646, 664 may include, for example, wired, wireless, or fiberoptic links. In another variation, the method and system operate in a stand-alone environment, such as on a single mobile device.

While aspects of the present invention have been described in connection with various features, it will be understood by those skilled in the art that variations and modifications of such aspects described above may be made without departing from the scope thereof. Other aspects will be apparent to those skilled in the art from a consideration of the specification or from a practice thereof.

1. A method for playing a content of a content-carrying file, the method implemented on a suitably programmed computer, the computer comprising a processor, a memory, and a user interface, the method comprising:
receiving the content-carrying file in an execution environment;
executing, via the processor, the content-carrying file;
providing a Content Defined Object (CDO) based on the execution of the content-carrying file;
based on the CDO, building one item selected from a group consisting of a user interface object, an interactive object, a logic script and an event-handling script; and
displaying the selected item via the user interface.

2. The method of claim 1, wherein the execution environment is a Java content-distribution framework, and the content-carrying file is a Javascript program.

3. The method of claim 1, further comprising:
filtering the content-carrying file.

4. The method of claim 1, wherein the selected object is modified based on user input.

5. The method of claim 1, further comprising:
downloading the execution environment on the suitably programmed computer.

6. The method of claim 1, wherein displaying the selected object comprises playing multimedia content.

7. The method of claim 1, wherein the suitably programmed computer is one of a mobile device and a desktop browser.

8. The method of claim 1, wherein executing of the content-carrying file is performed without using a network browser.

9. The method of claim 1, wherein building the selected object is performed at a user interface engine.

10. A system for playing a content of a content-carrying file, the system comprising:
a module for receiving the content-carrying file in an execution environment;
a module for executing the content-carrying file;
a module for providing a Content Defined Object (CDO) based on the execution of the content-carrying file;
a module for building one item selected from a group consisting of a user interface object, an interactive object, a logic script and an event-handling script, based on the CDO; and
a module for displaying the selected item via a user interface.

11. The system of claim 10, wherein the execution environment is a Java content-distribution framework, and the content-carrying file is a Javascript program.

12. The system of claim 10, further comprising:
a module for filtering the content-carrying file.

13. The system of claim 10, wherein the selected object is modified based on user input.

14. The system of claim 10, further comprising:
a module for downloading the execution environment on the suitably programmed computer.

15. The system of claim 10, wherein the selected object is displayed on a device for playing multimedia content.

16. The system of claim 15, wherein the device for playing multimedia content is one of a mobile device and a desktop browser.

17. The system of claim 10, wherein executing of the content-carrying file is performed without using a network browser.

18. The system of claim 10, wherein the selected object is built at a user interface engine.

19. A computer program product comprising a computer usable medium having control logic stored therein for causing a computer to play a content of a content-carrying file, the control logic comprising:
computer readable program code means for receiving the content-carrying file in an execution environment;
computer readable program code means for executing the content-carrying file;
computer readable program code means for providing a Content Defined Object (CDO) based on the execution of the content-carrying file;
computer readable program code means for building one item selected from a group consisting of a user interface object, an interactive object, a logic script and an event-handling script; and
computer readable program code means for displaying the selected item via the user interface.
